(19) United States
(12) Patent Application Publication
(10) Pub. No.: US 2018/0018747 A1
(43) Pub. Date: Jan. 18, 2018

(54) RISK BASED MEDICAL IDENTITY THEFT PREVENTION

(71) Applicant: Aetna Inc., Hartford, CT (US)

(72) Inventors: Ramesh Krishnan, Aurora, IL (US); Robert Rainwater, Columbia, CT (US); David Fitzgerald, Glenmoore, PA (US)

(21) Appl. No.: 15/651,577

(22) Filed: Jul. 17, 2017

Related U.S. Application Data
(60) Provisional application No. 62/363,614, filed on Jul. 18, 2016.

(51) Int. Cl. G06Q 50/26; G06F 19/00

(52) U.S. Cl. CPC G06Q 50/265; G06F 19/322; G06F 19/328

(57) ABSTRACT

Embodiments of the disclosure provide a medical identity theft prevention method performed by a computing server. The method includes: (a) registering an individual to an identity theft service, the registering comprising receiving individual identifying data from a computing device; (b) configuring a profile for the individual based on the individual identifying data; (c) monitoring use of a medical identity associated with the individual, the monitoring comprising receiving medical data from one or more provider devices; (d) determining from the medical data whether the medical identity is being misused; (e) in response to the determining that the medical identity being misused, alerting the individual through a victim device to the misuse of the medical identity; and (f) receiving a confirmation from the individual through the victim device, the confirmation indicating whether the medical identity is being used properly.

### CROSS-REFERENCE TO RELATED APPLICATIONS

This application claims the benefit of U.S. Provisional Application No. 62/363,614, filed on Jul. 18, 2016, which is hereby incorporated by reference in its entirety.

### BACKGROUND

Medical identity theft is increasing. Identity fraud and the compromising of a person's financial and personal data can be used to indulge in fraudulent activity. For example, a member of an insurance health plan may have his/her membership information stolen. The stolen membership information can then be used to fraudulently procure medical services. Seniors and children are especially susceptible and vulnerable. White collar crime damage in 2015 stood at $994 billion. Additionally, Medicare and Medicaid have recently paid out approximately $100 billion in a single year in fraudulent claims. Identity theft/fraud is poised to continue growing.

### SUMMARY

An embodiment of the disclosure provides a medical identity theft prevention method performed by a computing server. The computing server includes a processor to execute computer executable instructions stored on a non-transitory computer-readable medium, so that when the instructions are executed, the server performs the method comprising: (a) registering an individual to an identity theft service, the registering comprising receiving individual identifying data from a computing device; (b) configuring a profile for the individual based on the individual identifying data; (c) monitoring use of a medical identity associated with the individual, the monitoring comprising receiving medical data from one or more provider devices; (d) determining from the medical data whether the medical identity is being misused; (e) in response to the determination that the medical identity is being misused, alerting the individual through a victim device to the misuse of the medical identity; and (f) receiving a confirmation from the individual through the victim device, the confirmation indicating whether the medical identity is being used properly.

Another embodiment of the disclosure provides a server for medical identity theft prevention. The server includes a processor to execute computer executable instructions stored on a non-transitory computer readable medium, so that when the instructions are executed, the server is configured to: (a) register an individual to an identity theft service, wherein registering the individual, comprises receiving individual identifying data from a computing device; (b) configure a profile for the individual based on the individual identifying data; (c) monitor use of a medical identity associated with the individual, wherein monitoring use of the medical identity comprises receiving medical data from one or more provider devices; (d) determine from the medical data whether the medical identity is being misused; (e) in response to the determination that the medical identity is being misused, sending an alert to a victim device associated with the individual, the alert indicating the misuse of the medical identity; and (f) receive a confirmation from the individual through the victim device, the confirmation indicating whether the medical identity is being used properly.

### BRIEF DESCRIPTION OF THE SEVERAL VIEWS OF THE DRAWINGS

FIG. 1 illustrates an ecosystem for risk based identity theft prevention, according to an embodiment of the disclosure;

FIG. 2 illustrates another ecosystem for risk based identity theft prevention, according to an embodiment of the disclosure;

FIG. 3 is a block diagram illustrating components of a computing device, according to some example embodiments;

FIG. 4 is a block diagram illustrating components of a server, according to some example embodiments;

FIG. 5 is a sample flow diagram illustrating communication between entities in an ecosystem for risk based medical identity theft prevention, according to an embodiment of the disclosure;

FIG. 6 is another sample flow diagram illustrating communication between entities in an ecosystem for risk based medical identity theft prevention, according to an embodiment of the disclosure;

FIG. 7 is an example flow diagram illustrating determination of a risk score, according to an embodiment of the disclosure;

FIG. 8 is an example ecosystem for risk based medical identity theft prevention, according to an embodiment of the disclosure;

FIG. 9 illustrates a flow diagram for example steps involved in risk based medical identity theft prevention, according to an embodiment of the disclosure;

FIG. 10 illustrates an example system for registration and setup and configuration process flows, according to an embodiment of the disclosure;

FIG. 11 illustrates an example system for monitoring and alerting process flows, according to an embodiment of the disclosure;

FIG. 12 illustrates an example system for resolution process flow, according to an embodiment of the disclosure; and

FIG. 13 illustrates examples of interface systems providing services to the risk based identity theft prevention system, according to an embodiment of the disclosure.

### DETAILED DESCRIPTION OF THE INVENTION

Embodiments of the disclosure provide a system and method for dealing with identity theft based on a risk-based calculation. Identity theft can be a disturbing, as well as a life-altering process for an individual, and therefore, methods and systems that alleviate the stress involved or that mitigate the damage done to the individual, are beneficial. Additionally, identity theft not only affects an individual, but also the individual's community at large. For example, the identity theft may have insurance companies or government agencies involved, thereby utilizing community resources in order to tackle problems associated with the specific identity theft. Unfortunately, communities and individuals do not have unlimited resources, thus, methods and systems that aid in identifying identity theft in its infancy are beneficial.

Identity theft may occur in any area of society. For example, a person's identity may be used to fraudulently access bank account information in a financial institution or may be used to access confidential information at a hospital, a school, an insurance company, a governmental agency, etc. In addition to access, a person's identity may be used fraudulently to create additional history, for example, the creation of new medical records that the person may be liable for, or the creation of new trading transactions that the person may be liable for, etc. Although identity theft is a problem to society as a whole, for ease of description, embodiments of the disclosure will be explicated and described in a medical environment context. The medical environment context is provided as an example and is not meant to limit the applicability of the scope of the present application.

In an example, a person goes to a hospital for treatment because she hurt herself. She does not have insurance, so she gives the hospital staff another person's identity. In this scenario, the person providing the false identity is termed an identity thief and the person whose identity is being used fraudulently is an identity theft victim. An identity, as used in this disclosure, is one or more details identifying an individual, for example, the name of an individual, a social security number of the individual, the date of birth of the individual, and so on. Returning to the example, after the identity thief provides the victim's identity to the hospital staff, she receives treatment from the hospital, and the hospital, in turn, bills the victim's insurance. The victim's insurance pays the hospital bill according to the victim's coverage plan, and if any balance remains, the victim receives a bill for the remainder.

In some cases, a victim is unable or unwilling to pay for services he or she did not approve, so when the victim receives a bill for the remainder, the victim is pulled into a legal or procedural process of resolving the bill. Collection agencies may become involved in the process, and hospitals may continue pursuing compensation from the victim. Victims are not protected by the Fair Credit Reporting Act (FCRA), and as such, can be liable for compensating the hospital. Additionally, since the victim's insurance company may have already paid for a portion of the services that the identity thief received at the hospital, the amount paid may count towards a yearly maximum allotted to the victim. The amount may also be used to determine insurance premiums at the time for renewal of the victim's coverage plan.

In the medical space example, a victim might have a very difficult time disputing the bill due to legal structures in place. For example, when the victim approaches the hospital to see his/her medical records for validation, the hospital may deny access, since the treatment provided to the identity thief is now a part of the victim's medical history. The hospital revealing the identity thief's medical history to the victim, when not authorized to do so, can be found in violation of federal privacy law.

Identity theft may also endanger a victim's life, when gone unnoticed. For example, if an identity thief has a medical procedure performed, such as an appendectomy, using a stolen identity of the victim, based on the medical recorder, healthcare providers will assume that the appendectomy procedure has been completed. So, if for instance, the victim reaches out to a healthcare provider complaining of abdominal pain, the healthcare provider may rule out appendicitis, since the victim's record shows that the victim's appendix has already been removed. Medical identity theft, thus, has implications on the health and safety of victims and could put the victims' health at risk. Along the same lines, a child's identity is prized more than an adult, since a child's identity is less likely to be monitored. An identity thief who steals a child's identity can get away with using that child's identity for a longer time period.

In general, there is never a good time to be a victim of identity theft. With concerns of computer network hacking and widespread news of successful attempts at stealing pertinent information, such as social security numbers, credit card numbers, online passwords, and so on, a reasonable position is to assume that the identities of a large number of people have already been compromised. Thus, it is just a matter of time before these identities are sold/bought in the black market and then subsequently used. Thus, the embodiments of the disclosure provide a system and method of monitoring, preventing and detecting fraudulent use of a person's identity and issue alerts in real time.

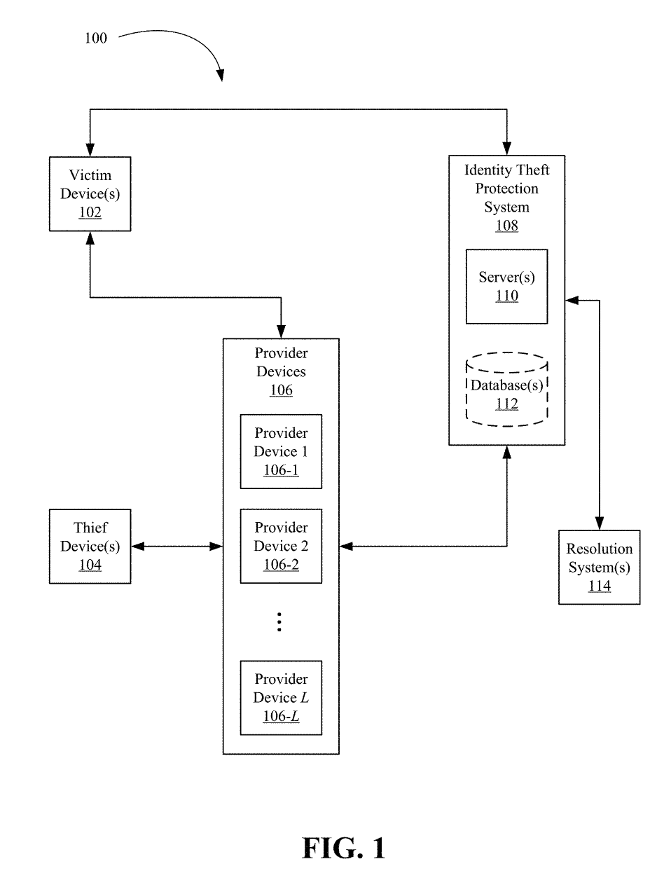

FIG. 1 illustrates an ecosystem 100 for risk-based identity theft prevention, according to an embodiment of the disclosure. Ecosystem 100 may include one or more devices belonging to a victim of identity theft (victim device(s) 102), one or more devices belonging to an identity thief (thief device(s) 104), one or more devices belonging to one or more service providers (provider devices 106), an identity theft protection system 108, and resolution system(s) 116. The provider devices 106 may communicate with the victim device(s) 102, thief device(s) 104, and the identity theft protection system 108. The identity theft protection system 108 may communicate with victim device(s) 102, resolution system(s) 114, and provider devices 106.

The victim device(s) 102 and the thief device(s) 104 are computing devices used by an identity thief victim and an identity thief, respectively. For ease of description, the singular form will be used for the victim device(s) 102 and the thief device(s) 104, by default, and the plural form will be used, when appropriate. Exemplary computing devices for the victim device 102, and the thief device 104 include mobile devices, e.g., a smartphone, a tablet, a phablet, a smart watch, a fitness tracking device, and the like. Computing devices may also include larger devices, for example, a smart television, a laptop computer, a desktop computer, and the like. Computing devices may also include communication devices for voice and/or video calls, e.g., telephones and computers with microphones and cameras.

The provider devices 106 include one or more devices belonging to one or more service providers. A service provider is an entity that offers a service. A service provider may, for example, be a healthcare facility, a financial institution, a governmental agency, an insurance company, a car dealership, or any other organization providing a service. The service provider may have one or more provider devices 106 to facilitate the realization of its goals. The one or more provider devices 106 may include servers, databases, laptops, desktops, or other computing devices. Provider devices 106 in FIG. 1 is shown to include provider device 1 106-1 to provider device L 106-L. This indicates that the different provider devices 106 may be configured to network with one another. For example, provider device 1 106-1 in a healthcare facility may communicate with provider device 5 106-5 at an insurance company.

The identity theft protection system 108 is a computing infrastructure with one or more server(s) 110 and one or more database(s) 112 for the monitoring, preventing and detecting of fraudulent use of a person's identity. The identity theft protection system 108 may also issue alerts to the victim devices 102 and the provider devices 106 in real time.

The ecosystem 100 may also include resolution system(s) 114, which is one or more computing infrastructures to support one or more resolution teams that aid an identity theft victim in resolving issues related to identity theft and identity misuse. The resolution system(s) 114 may include one or more servers, desktop computers, laptop computers, and the like.

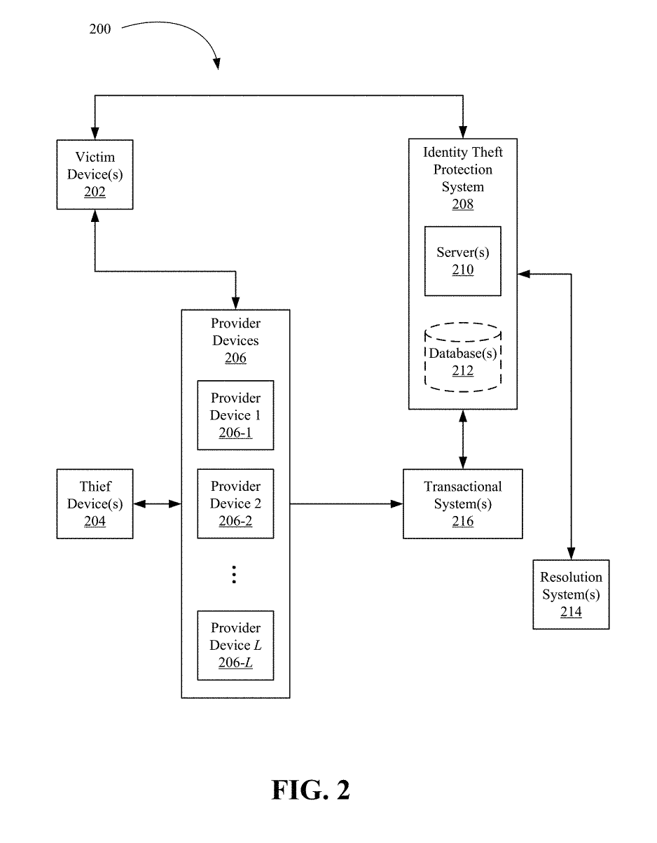

FIG. 2 illustrates another ecosystem 200 for risk-based medical identity theft prevention according to an embodiment of the disclosure. The ecosystem 200 includes victim device(s) 202, thief device(s) 204, provider devices 206, identity theft protection system 208, resolution system(s) 214, and transactional system(s) 216. Victim device(s) 202, thief device(s) 204, provider devices 206, identity theft protection system 208, and resolution system(s) 214 are analogous to their counterparts, already described above with respect to FIG. 1. The ecosystem 200 introduces transactional system(s) 216 as an intermediary between the identity theft protection system 208 and provider devices 206.

Transactional system(s) 216 are one or more servers/databases that log transactions. For example, a patient may visit a hospital, provide his medical insurance information, and receive treatment. The hospital may then submit an insurance claims request transaction for the treatment provided to the patient. The claims request would be provided to the transactional system(s) 216 for processing. The identity theft protection system 208 monitors the one or more transactional system(s) 216 to determine whether an individual's identity has been stolen.

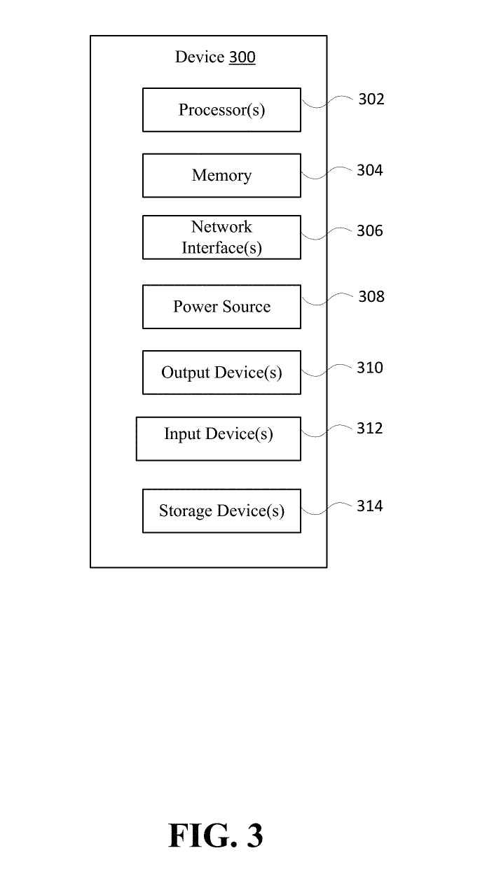

FIG. 3 is a block diagram illustrating basic hardware components of a computing device that may be used in identity theft prevention, according to some example embodiments. Device 300 may be an embodiment of the victim device 102, the thief device 104, or one provider device 106. Device 300 may include one or more processors 302, memory 304, network interfaces 306, power source 308, output devices 310, input devices 312, and storage devices 314. Although not explicitly shown in FIG. 3, each component provided is interconnected physically, communicatively, and/or operatively for inter-component communications in order to realize functionality ascribed to the one or more victim device(s) 102, the thief device(s) 104, or provider devices 106. To simplify the discussion, the singular form will be used for all components identified in FIG. 3, when appropriate, but the use of the singular does not limit the discussion to only one of each component. For example, multiple processors may implement functionality attributed to processor 302.

Processor 302 is configured to implement functions and/or process instructions for execution within the device 300. For example, processor 302 executes instructions stored in memory 304 or instructions stored on a storage device 314. In certain embodiments, instructions stored on storage device 314 are transferred to memory 304 for execution at processor 302. Memory 304, which may be a non-transient, computer-readable storage medium, is configured to store information within the device 300 during operation. In some embodiments, memory 304 includes a temporary memory that does not retain information stored, when the device 300 is turned off. Examples of such temporary memory include volatile memories such as random access memories (RAM), dynamic random access memories (DRAM), and static random access memories (SRAM). Memory 304 also maintains program instructions for execution by the processor 302 and serves as a conduit for other storage devices (internal or external) coupled to the device 300 to gain access to processor 302.

Storage device 314 includes one or more non-transient computer-readable storage media. Storage device 314 is provided to store larger amounts of information than memory 304, and, in some instances, configured for long-term storage of information. In some embodiments, the storage device 314 includes non-volatile storage elements. Non-limiting examples of non-volatile storage elements include floppy discs, flash memories, magnetic hard discs, optical discs, solid state drives, or forms of electrically programmable memories (EPROM) or electrically erasable and programmable (EEPROM) memories.

Network interfaces 306 are used to communicate with external devices and/or servers. The device 300 may comprise multiple network interfaces 306 to facilitate communication via multiple types of networks. Network interfaces 306 may comprise network interface cards, such as Ethernet cards, optical transceivers, radio frequency transceivers, or any other type of device that can send and receive information. Non-limiting examples of network interfaces 306 include radios compatible with several Wi-Fi standards, 3G, 4G, Long-Term Evolution (LTE), Bluetooth®, etc.

Power source 308 provides power to the device 300. For example, the device 300 may be battery-powered through rechargeable or non-rechargeable batteries, utilizing nickel-cadmium or other suitable material. Power source 308 may include a regulator for regulating power from the power grid in the case of a device plugged into a wall outlet, and in some devices, power source 308 may utilize energy scavenging of ubiquitous radio frequency (RF) signals to provide power to the device 300.

The device 300 may also be equipped with one or more output devices 310. Output device 310 is configured to provide output to a user using tactile, audio, and/or video information. Examples of output device 310 may include a display (cathode ray tube (CRT) display, liquid crystal display (LCD) display, LCD/light emitting diode (LED) display, organic LED display, etc.), a sound card, a video graphics adapter card, speakers, magnetics, or any other type of device that may generate an output intelligible to a user of the device 300.

The device 300 may also be equipped with one or more input devices 312. Input devices 312 are configured to receive input from a user or the environment where the device 300 resides. In certain instances, input devices 312 include devices that provide interaction with the environment through tactile, audio, and/or video feedback. These may include a presence-sensitive screen or a touch-sensitive screen, a mouse, a keyboard, a video camera, microphone, a voice responsive system, or any other type of input device.

The hardware components described thus far, for the device 300, are functionally and communicatively coupled to achieve certain behaviors. In some embodiments, these behaviors are controlled by software running on an operating system of the device 300.

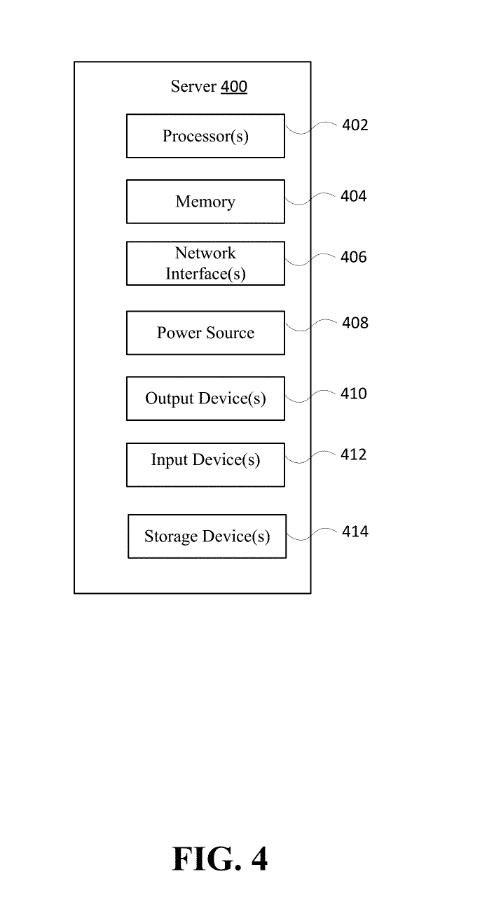

FIG. 4 is a block diagram illustrating components of a server 400 that may be used in identity theft prevention, according to some example embodiments. The behavior, function, and description of the various components are analogous to those already described for the device 300. For example, server 400 may include one or more processors 402, memory 404, network interfaces 406, power source 408, output devices 410, input devices 412, and storage devices 414. The description for these components will not be provided, but it is understood that examples of these components may include those already provided for the device 300.

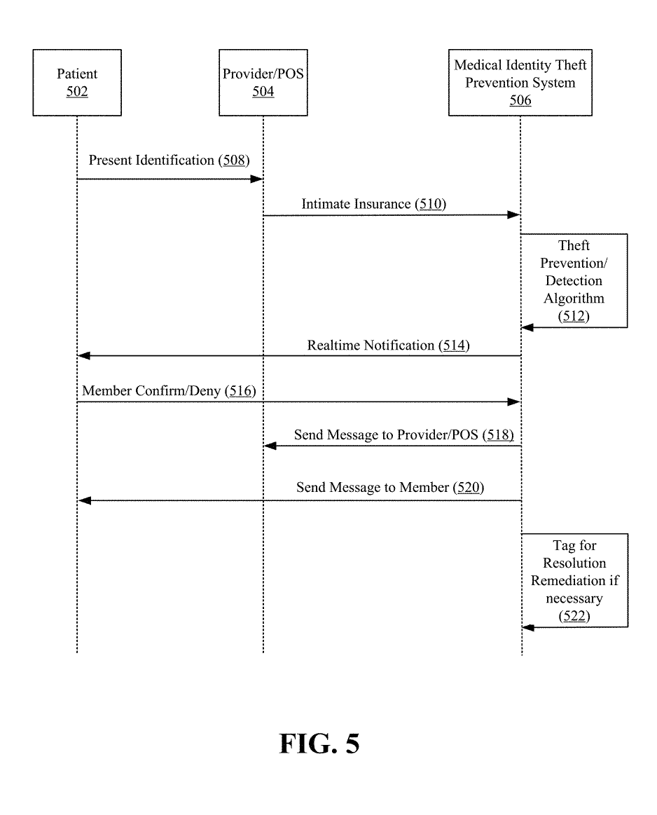

FIG. 5 is a sample flow diagram illustrating communication between entities in an ecosystem for risk-based medical identity theft prevention, according to an embodiment of the disclosure. The patient 502, provider/POS 504, and medical identity theft prevention system 506 may be related to different entities provided in ecosystem 100. At step 508, the patient 502 provides his or her identification information to the provider or point of service (POS) 504. The provider/POS 504 may be a clinic, hospital, or another healthcare facility. The patient 502 may provide identification information in various ways, for example, presenting in-person a social security card, a passport, a driver's license, date of birth, medical insurance card, and the like. The patient 502 may also pre-register with the provider/POS 504 and provide identification information online through a computing device, for example, the device 300.

At step 510, the provider/POS 504 relays the identity information obtained at step 508 to the medical identity theft prevention system 506. The medical identity theft prevention system 506 is an embodiment of the identity theft protection system 108. The provider/POS 504 may relay, for example, intimate insurance information to the medical identity theft prevention system 506.

At step 512, the medical identity theft prevention system 506 incorporates the information obtained by the provider/POS 504 at step 510 in a theft prevention/detection algorithm.

At step 514, the medical identity theft prevention system 506 notifies the patient 502 that his/her identity is being used. The notification provided to the patient 502 may include the provider/POS 504 address and other information associated with the provider/POS 504. The notification may also include a request to confirm or deny whether the identity of the patient 502 is being used properly.

At step 516, the patient 502 may either confirm or deny proper use of his/her identity.

At step 518, the medical identity theft prevention system 506 may send a confirmation message to the provider/POS 504 acknowledging whether the identity checks out.

At step 520, the medical identity theft prevention system 506 may send a confirmation message to the patient 502 acknowledging receipt of the member's confirmation or denial.

Note, in this example, the member and the patient are the same individual. If the patient 502 denied the notification at step 514 and the medical identity theft prevention system 506 determined that the identity of patient 502 is not being used properly, then at step 522, the identity information received at step 510 is tagged for resolution remediation.

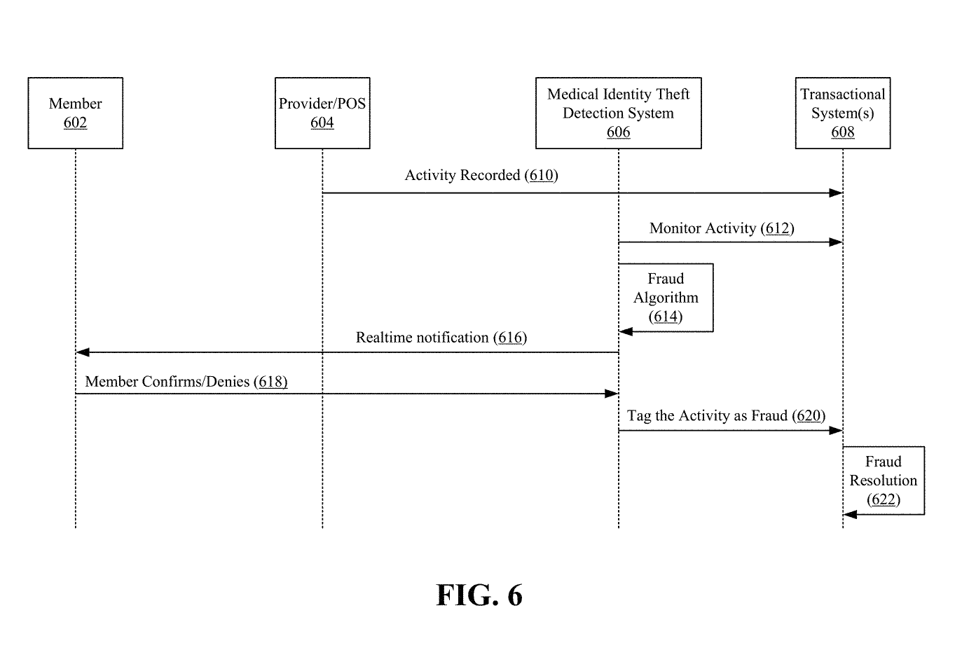

FIG. 6 is another sample flow diagram illustrating communication between entities in an ecosystem for risk-based medical identity theft prevention according, to an embodiment of the disclosure. The member 602, provider/POS 604, and medical identity theft detection system 606 and transactional system(s) 608 may be related to different entities provided in ecosystem 200. At step 610, the provider/POS 604 records an activity at transactional system(s) 608. In an example, a hospital may be the provider/POS 604, and the hospital may file a medical claim with an insurance company's claims processing servers/system.

At step 612, the medical identity theft detection system 606 monitors activities recorded at the one or more transactional system(s) 608. The medical identity theft detection system 606 is an embodiment of the identity theft protection system 208. In one example, the medical identity theft detection system 606 may inspect and identify new medical claims data.

At step 614, the medical identity theft detection system 606 may put newly identified activities through a fraud algorithm. For example, the medical identity theft detection system 606 may extract information from a newly-filed medical claim and determine whether information in the claim raises a concern of identity theft.

At step 616, the medical identity theft detection system 606 notifies the member 602 that his/her identity is being used.

At step 618, the member 602 may either confirm or deny proper use of his/her identity.

At step 620, if the member 602 indicates improper use of his/her identity, the medical identity theft detection system 606 tags the activity as fraud. In one example, a medical claim may be tagged.

At step 622, the transactional system(s) 608 undergoes a fraud resolution if the activity recorded at step 610 is tagged as fraud. An example of a task under fraud resolution may be to reissue a new identity for the member 602.

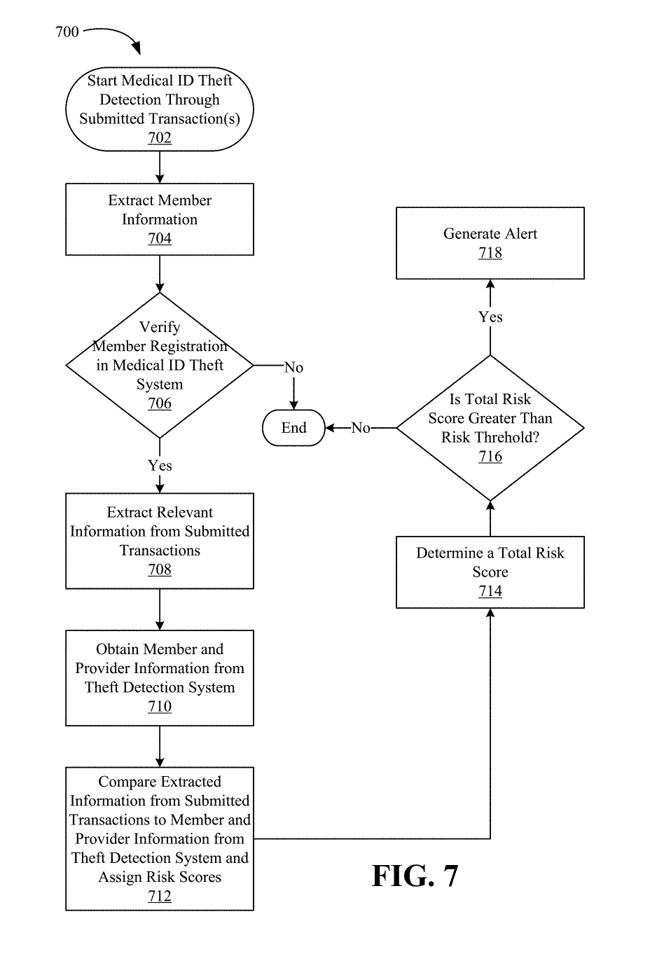

Step 512 involves running a theft prevention/detection algorithm, and step 614 involves running a fraud algorithm. FIG. 7 illustrates an example flow diagram showing a process 700 that may be used in theft prevention/detection and fraud according to an embodiment of the disclosure. The process 700 involves determination of a risk score associated with a transaction. At step 702, a medical transaction is submitted to the transactional system 216 by the provider devices 206. The transaction may include one or more Electronic Data Interchange (EDI) transactions, for example, the transaction may include an EDI American National Standards Institute (ANSI) 270 describing an eligibility transaction, an EDI ANSI 278 transaction describing a precertification transaction, and an EDI ANSI 837 describing a claim transaction.

At step 704, the identity theft protection system 208 detects the newly submitted transaction, starts a medical identity (ID) theft detection process, and extracts member identifying information from the submitted transaction. In one embodiment, the identity theft protection system 208 extracts the full name of the member identified in the eligibility, precertification, and claims transactions.

At step 706, the identity theft protection system 208 verifies whether the member identified at step 704 is registered in the medical ID theft program. If the member is not registered, then the identity theft protection system 208 stops processing the added transactions for determination of identity fraud.

At step 708, if the member is registered in the program, then the identity theft protection system 208 extracts relevant information from the submitted transaction. For example, the identity theft protection system 208 may extract member address information, provider address information, provider characteristics, service type, composite medical procedure ID, and so on.

At step 710, the identity theft protection system 208 obtains member and provider information from its repositories, for example, database(s) 212. Member information stored in its repositories may include member name, passwords, electronic health records, and so on; and provider characterisitics stored in its repositories may include provider name, provider address, provider identifier number (PIN), provider tax identification number, and so on.

At step 712, the identity theft protection system 208 compares the extracted information from submitted transactions of step 708 to member and provider information obtained at step 710, and assigns risk scores to each comparison. For example, if the member address from EDI transactions does not match the member address obtained from the repositories, a risk score is assigned to this comparison. If the provider's address is unreasonably outside of the member's geographic profile, a risk score is assigned to this comparison. In one example, if a member visits a provider 100 miles away for a routine health check, when past history indicates that past provider visits have been within 10 miles of home, a risk score is assigned. If the provider information does not match the member's provider preferences stored in the repositories, a risk score is assigned. In one example, a member visits a provider that is different from the member's care team, thus, a risk score is assigned. If the service type and/or composite medical procedure identifier does not match the member's demographic or medical history profile, then a risk score is assigned. In one example, the EDI transaction calls for treatment for appendicitis, but the member's medical history suggests that an appendectomy has already been performed, thus, a risk score is assigned.

At step 714, the identity theft protection system 208 determines a total risk score by summing the risk scores assigned for each comparison at step 712.

At step 716, the identity theft protection system 208 compares the total risk score against a risk threshold to determine whether to generate an alert. If the total risk score is less than or equal to the risk threshold, then the process 700 ends with no alert generated. If the total risk score is greater than the risk threshold, then an alert is generated at step 718. Other combinations are possible, for example, instead of a greater than relationship, a greater than or equal to relationship may be utilized.

At step 718, the identity theft protection system 208 generates one or more alerts by providing messages to the victim device(s) 202. In another embodiment, for example, in ecosystem 100, where the identity theft protection system 108 communicates directly with the provider devices 106, the identity theft protection system 108 may further provide a hold message to the provider devices 106 while waiting for confirmation from the victim device(s) 202 that the EDI transactions are not fraudulent.

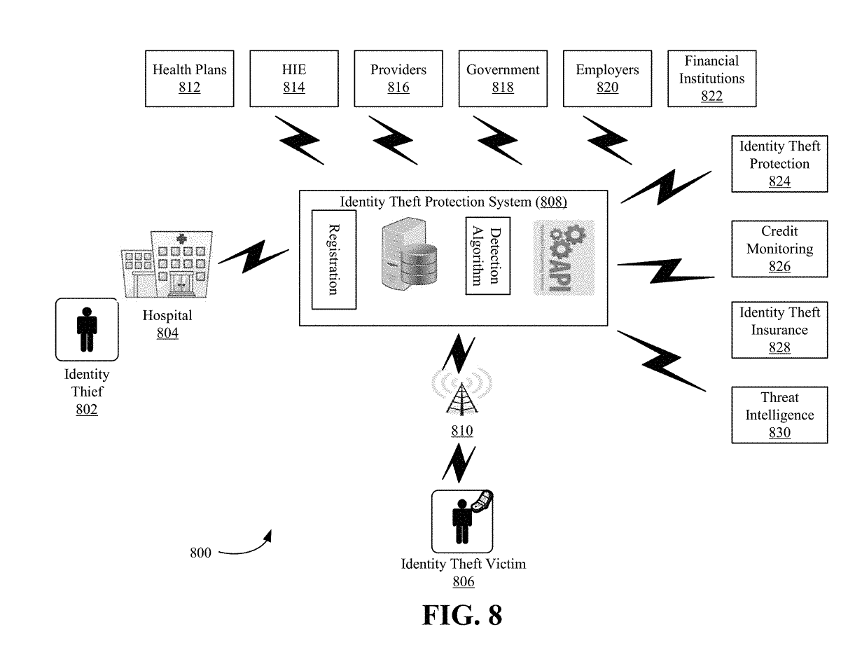

FIG. 8 illustrates an ecosystem 800 for risk based medical identity theft prevention, according to an embodiment of the disclosure. The ecosystem 800 includes an identity thief 802 visiting a hospital 804. The hospital 804 is connected to an identity theft protection system 808, which may be connected to multiple agencies, databases, and records. For example, the identity theft protection system 808 may be connected to individuals' health plans 812, health information exchanges (HIE) 814, government agencies 818, multiple employers 820, financial institutions 822, identity theft protection companies 824, credit monitoring companies 826, identity theft insurance companies 828, threat intelligence 830, and other providers 816. Threat intelligence 830 encompasses data gathered to support defensive actions, for example, data including procedures already performed on a member, medical history of the member, gender, age appropriate procedures, and data used for acquiring risk scores, and risk scores. The identity theft protection system 808 may choose which of these agencies, databases, and records are applicable based on an identity theft victim 806 and may communicate through a network 810 with the identity theft victim 806. The identity theft protection system 808 is analogous to the identity theft protection system 108 of FIG. 1. The identity theft protection system 808 includes servers and databases that support member registration, run application programming interfaces (APIs), and run fraud or identity theft detection algorithms.

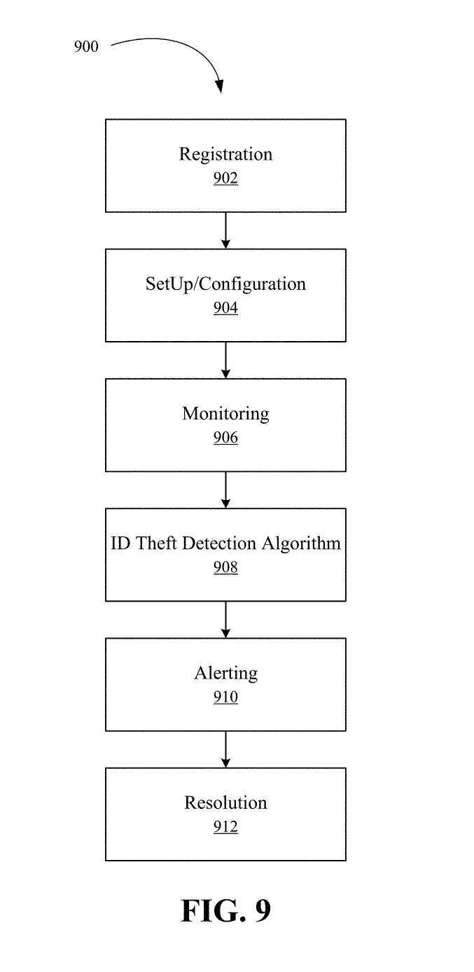

FIG. 9 is a flow diagram illustrating a process 900 for risk-based medical identity theft prevention, according to an embodiment of the disclosure. The ecosystem 800 will be used to describe the individual steps of the process 900. Step 902 involves registration, that is, an entity (individual or organization) registers for a Medical ID theft monitoring and alerting service with the identity theft protection system 808. During registration, the entity provides individual identifying data to the identity theft protection system 808.

Step 904 is a setup and configuration step, where the entity is configured in the identity theft protection system 808. The identity theft protection system 808 utilizes a unique data model that is amenable to detecting Medical ID misuse. The unique data model may be extensible to include vulnerable populations like children and seniors. The unique data model may accommodate risk profiles and risk scores. The identity theft protection system 808 configures the subscribing entity's profile based on the entity's preferences. Thus, after configuration, the subscribing entity will be referred to as the subscriber.

Step 906 involves monitoring changes in the ecosystem 800. The identity theft protection system 808 monitors the ecosystem 800 for use of the subscriber's Medical ID. The identity theft protection system 808 collects, contextualizes and monitors relevant data from the ecosystem 800. In one example, the identity theft protection system 808 leverages relevant APIs to collect and contextualize information related to the Medical ID use. In another embodiment, the identity theft protection system 808 is configured to log an individual's preferences for medical care, for example, the individual's primary care physician, local hospitals, regional specialties, and the like.

Step 908 involves running the Medical ID theft detection algorithm. The identity theft protection system 808 utilizes information collected from the various agencies and providers identified in the ecosystem 800 and runs them through the detection algorithm. The detection algorithm may be, for example, process 700. The detection algorithm may leverage federated/aggregated data, transform the data, and apply relevant analytics to inform misuse scenarios. Relevant analytics include a study of gathered/collected data at step 904 to assign risk and may be associated with security-based “risk scoring”. In the study of the gathered data, a score is rendered to associate risk of theft. Risks scores may be associated based on, for example, a subscriber's (or member's) historical usage patterns; a provider in a geographic range of the member; does the member's address on a proof of ID match the member's address obtained at an earlier time?; does a scheduled procedure match the member's age, gender or past procedures?; is the member's healthcare plan on a presented card current?; and so on.

In some embodiments, the detection algorithm may be a dynamic ever-changing rules-based system that may be continuously updated as increased or changing medical identity theft detection algorithms are discovered.

Step 910 involves alerting the member or subscriber to potential misuse of Medical ID. The identity theft protection system 808 uses unique communication protocols and logic to generate alerts to subscribers. The determination of whether to alert subscribers is performed in lock step with the monitoring of step 908 to allow for near “real time” alerting of subscribers. In some embodiments, when the member registers at step 902, the identity theft protection system 808 collects, from the member, their preferred methods of communicating alerts, messages, and updates. Some example methods include text messaging, phone calls, email, and the like.

Step 912 involves resolution. Step 912 is performed when there are issues arising from Medical ID theft. At step 912, the identity theft protection system 808 may generate an alternate Medical ID for the member (in this case the identity theft victim 806). The identity theft protection system 808 may assign a special team to the member to resolve issues arising from the Medical ID theft or misuse. The identity theft protection system 808 may leverage threat intelligence 830 and share information across the ecosystem 800 to serve as an early warning system to help providers, agencies, and companies in the ecosystem 800 take appropriate actions.

In an embodiment, the identity theft protection system 808 may parse the member's medical record to determine items in the medical record that do not belong to the member. The identity theft protection system 808 may cleanse the member's medical record of the items identified. For example, the identity theft protection system 808 may determine that an appropriate action is to remove stolen or falsely updated medical, financial, or insurance records.

In an embodiment, the identity theft protection system 808 may compile and provide documentation for law enforcement, depending on what information was stolen, as to how the information was stolen, and the steps required for remediation. For example, if a medical card were stolen and a diagnosis and resulting procedure were performed, the identity theft protection system 808 may perform a thorough review of the impacts of the stolen medical card on the member's medical record. Items in the member's medical record may be traced, remediated and expunged in differing manners, based on the use of the stolen medical card.

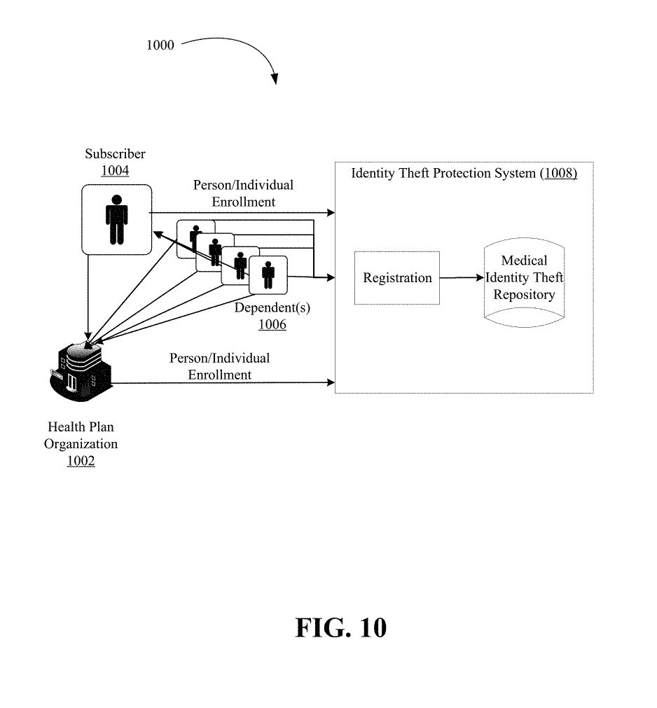

FIG. 10 illustrates an example system 1000 for registration and setup and configure process flows, according to an embodiment of the disclosure. The identity theft protection system 1008 is analogous to the protection systems shown in FIGS. 1-2. The identity theft protection system 1008 may support registration for a medical identity theft service by a subscriber 1004, a subscriber's dependents 1006, or an organization 1002 on behalf of the subscriber and/or on behalf of the subscriber's dependents. The subscriber 1004 may be defined as a person who initiates an insurance policy. In more general terms, the subscriber 1004 may be a person or an individual who wishes to protect his/her medical identity.

The registration process running in the identity theft protection system 1008 is an enrollment process that collects information about the subscriber 1004 and/or his/her dependents 1006 to make them eligible for the Medical ID theft protection prevention services. The ecosystems of FIG. 1 and FIG. 2 support the registration of an entity by either the victim devices, for example, victim device 102, or the provider devices, for example, provider device 106. Data/information collected may be stored in the medical identity theft repository. The medical identity theft repository may include data ontology that relates the collected data to the subscriber 1004 as well as to the health care industry. Some of the data collected may include: the individual's name, passwords, one or more picture(s), secret or security questions and/or answers, addresses, phone numbers, primary, secondary provider(s) and tertiary contacts, medical identification numbers in clinical records (e.g., electronic medical records (EMR), personal health records (PHR), clinical systems, and the like), medical insurance IDs, driver's license (and other forms of ID to ensure the unique identification of the person/individual being protected), historical medical plans, subscriber references or information about individuals that help further qualify the subscriber, past and current medical conditions or EMR, electronic health records (EHR) and PHR references. Collected data may also include social media references, e.g., data links that will help identify medical ID theft or fraudulent use, as well as logs of use, messages, audits, etc.

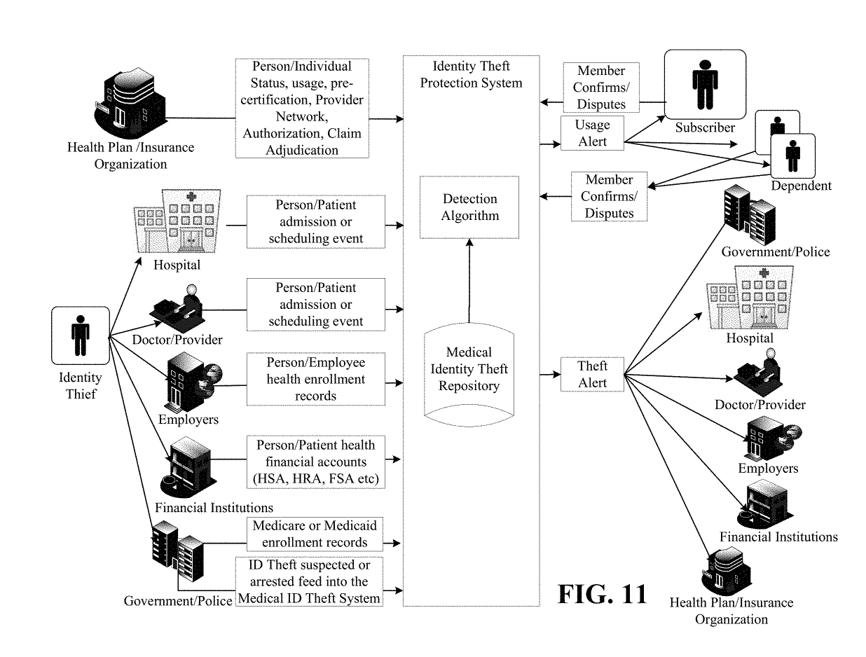

FIG. 11 illustrates an example system for monitoring and alerting process flows, according to an embodiment of the disclosure. FIG. 11 provides a graphical depiction of several types of entities in an ecosystem monitored by the identity theft protection system. While monitoring, a decision algorithm is being run comparing newly-acquired monitored data with data present in the medical identity theft repository. When an identity theft is suspected, an alert is provided to the subscriber and/or dependents. When an identity theft occurs, an alert is provided to the multiple agencies, companies, providers, etc.

In the embodiment of FIG. 11, during monitoring, as health plan organizations conduct business, enroll members, process member eligibility, adjudicate claims, authorize procedures, and so on, the identity theft protection system invokes APIs to ensure that the individual being processed is true. During monitoring, hospitals, doctors, and other healthcare providers may want to ensure that the individual being provided services is the “authorized” person/patient, and not a thief. The identity theft protection system may verify an individual's identity at the point of scheduling, enrollment, or admission. In an example, at a previous time period, for example, on a previous day, as providers perform eligibility validation checks with health plans, providers at a next time period, for example, a next day, may preform real-time medical identity checks on the patient/individual, as well. During monitoring, when employers pass records to health plans for enrollment purposes, a Medical identity check may occur to ensure that other fraudulent avenues are removed from access. During monitoring, medical payments made through financial institutions may be validated. In an embodiment, before payments are made to providers for services, financial institutions 822 can send specific validation content to the identity theft protection system 808, which then determines whether services provided should be paid for. During monitoring, the government may have plans with members enrolled through Medicare and Medicaid, and identities of these enrolled members may be checked, as the government is a known theft target. During monitoring, if police or authorities are notified by other means (for example, local providers or citizens) of medical identity loss or suspected loss, the police or authorities may provide this data to the identity theft protection system to log and possibly remediate.

In the embodiment of FIG. 11, during alerting, the subscriber/member may be alerted of healthcare activity in real-time. The subscriber may interact in real-time with the identity theft prevention system to confirm activity or deny/dispute the activity. If the subscriber flags an activity, the activity becomes tagged by the medical identity theft prevention system, and secondary approval and cleansing processes take effect. In an embodiment, a secondary approval process involves having the subscriber approve any new activity, for example, any new uses of his/her identity, until the cleansing process is completed. During alerting, the government and/or police may be notified in real-time to the medical identity theft. Once notifications have been sent, the potential impact of the identity theft can be documented by the identity theft prevention system by, for example, logging receipts. During alerting, hospitals, providers/doctor offices, employers, financial organizations and health plans associated with the identity theft may be notified of the theft in real-time of the subscriber's denial or theft alert. Once notifications have been sent, the potential impact of the identity theft can be documented by the identity theft prevention system, by for example, logging receipts.

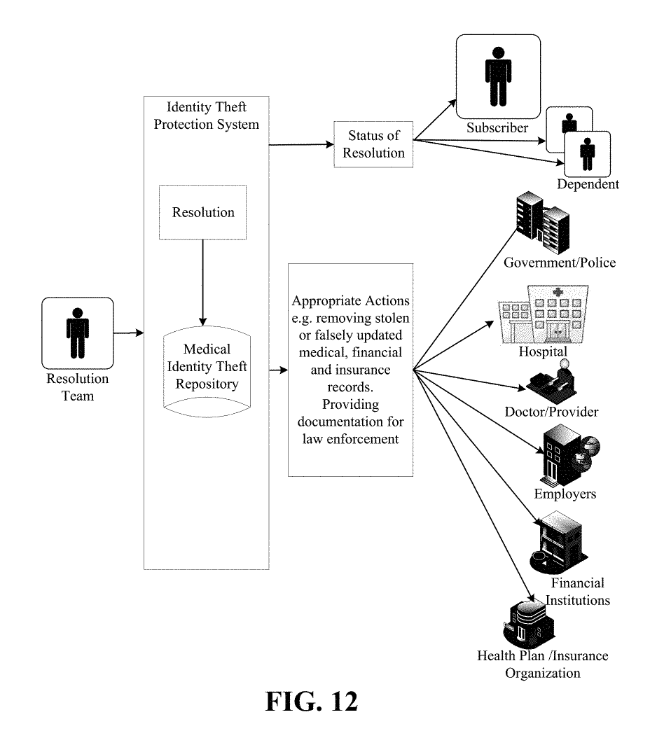

FIG. 12 illustrates an example system for resolution process flow, according to an embodiment of the disclosure. Threat Intelligence is leveraged and information shared across the medical identity theft prevention ecosystem to serve as both an early warning system and a resolution ecosystem to help participants (from the subscribers to the stakeholders) take appropriate actions. In FIG. 12, during resolution, a resolution team may be assigned to a victim of identity theft. The resolution team is a special team in the medical identity theft prevention ecosystem that may inform and assist other stakeholders (hospitals, providers, employers, police, financial institutions, etc.) connected to the victim. The resolution team may also resolve issues arising from ID theft and misuse by, for example, clearing any medical logs that are not those of the subscriber.

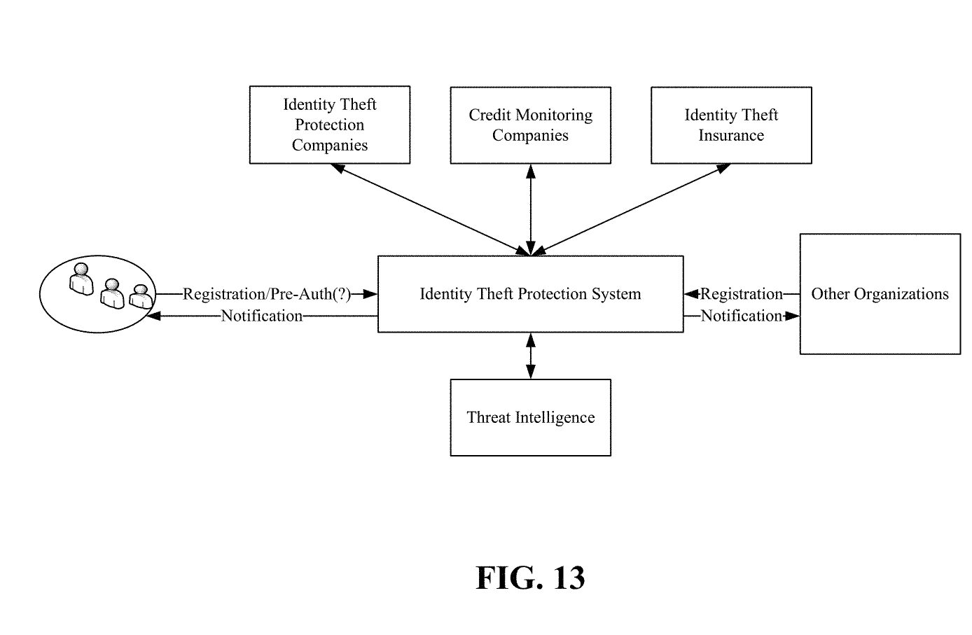

FIG. 13 illustrates examples of interface systems providing services to the risk based identity theft prevention system, according to an embodiment of the disclosure. If a member's credit rating is negatively impacted, it may have health implications. The health implications may include adverse effects to mental health and inability to access credit for potentially critical healthcare services. The identity theft protection system may partner with credit rating agencies to monitor the member's credit ratings and proactively reach out to ensure wellness etc. For example, if an identity is violated in a credit situation, there may be a higher risk that the medical ID could be violated as well. The identity theft protection system may partner with credit activity monitoring agencies to offer real-time notification of identity theft (e.g., Payflex offers identity theft services to members). The identity theft protection system, in partnership with the credit activity monitoring agencies, allows the agencies to notify the theft protection system and vice versa, when identity violations occur.

Embodiments of the disclosure provide a system for risk-based medical identity theft protection capable of registering an individual or an organization for medical identity theft prevention, detection, monitoring, and alerting services. The system is capable of setting up and/or configuring a profile or preferences for an individual, and allowing the description of the individual through a Medical ID. The Medical ID uniquely identifies the individual and may be related to the individual's name, address, social security number, driver's license, voter registration, passport, and so on.

Embodiments of the disclosure provide a system that is able to protect the Medical ID of the individual and protect data related to the medical ID of the individual. The data protected may include the individual's medical records, for example, EHR, EMR, PHR, and so on. The data protected may include medical-related financial records, for example, health reimbursement accounts (HRAs), flexible spending accounts (FSAs), health savings accounts (HSAs), and so on. The system performs data protection, when performing a resolution or remediation process as described, for example, at step 912. During resolution, the system searches for medical, financial, and other records that may have been impacted by identity theft. Records identified as impacted are then reviewed, traced, corrected, and/or expunged in differing manners, based on the stolen identity information used by an identity thief.

Embodiments of the disclosure provide a system that is able to monitor an individual's medical identity risk, for example, categorization in specific populations like young children, or the elderly. The system may be able to monitor whether an individual's medical identity is potentially being used fraudulently through a detection algorithm, for example, process 700. The system is also able to monitor that an individual's medical identity is being used and may provide an alert for validation of the medical identity use. In some cases, when a total risk score calculated is too high (being greater than a risk threshold), the medical identity is locked until validation is completed. When the medical identity is locked, providers are alerted by the system to hold off on accepting the medical identity until further notice. In some cases, a secondary approval process may be activated so the individual approves each further use of the medical identity. The system may invoke near or real-time alerts to healthcare providers, other providers, and an identity victim of a potential theft.

The system may use data models specifically designed to assess medical identity risk profiles. Some of the data used to create the data models include items stored in the theft repository during registration, for example, pictures, passwords, individual's name, and so on. The system may analyze historical data for patterns of medical identity use by the individual in cognitive systems to perform early, and potentially, to prevent medical identity fraud. The system may accommodate medical identity threat and theft preferences for the covered individual, for example: an individual lives in Hartford and travels often to Philadelphia, and vacations in July in Atlantic City, N.J. The system may detecting patterns of medical identity fraud and leveraged data against historical patterns to prevent medical identity theft. Over time, the system may learn best practices for communicating alerts, risks, and potential risks. The system may adapt and change how alerts, risks and potential theft communications can change as the subscriber and systems change.

Embodiments of the disclosure provide a system that may resolve medical identity corruptions arising from theft and/or misuse, for example, removing fraudulent medical procedures from related records, recovering financial impacts, and issuing a corrected identity. The system may help recognize an individual at a point of service and prevent medical identity theft. The system may ensure the medical safety of the individual. The system may protect the medical safety of the individual subscriber. As electronic systems pass medical diagnoses, procedures and conditions to other larger systems, and those impact the future diagnoses and treatments of the individual/subscriber, systems designed in accordance with various embodiments of the disclosure protect the continuity and accuracy of that data to ultimately protect the future treatment and potentially save the life of the individual/subscriber.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A medical identity theft prevention method performed by a computing server, the computing server comprising a processor to execute computer executable instructions stored on a non-transitory computer readable medium, so that when the instructions are executed, the server performs the method comprising:
registering an individual to an identity theft service, the registering comprising receiving individual identifying data from a computing device;
configuring a profile for the individual based on the individual identifying data;
monitoring use of a medical identity associated with the individual, the monitoring comprising receiving medical data from one or more provider devices;
determining from the medical data whether the medical identity is being misused;
in response to the determining that the medical identity being misused, alerting the individual through a victim device to the misuse of the medical identity; and
receiving a confirmation from the individual through the victim device, the confirmation indicating whether the medical identity is being used properly.

2. The method according to claim 1, further comprising:
tagging the medical data for resolution, resolution comprising assigning the profile for the individual to a special team, wherein the tagging is performed based on the confirmation indicating that the medical identity is not being used properly; and
performing resolution on the medical identity.

3. The method according to claim 2, wherein resolution further comprises:
determining that a medical record of the individual is falsely updated; and
cleansing the medical record of the individual of the false updates, the cleansing comprising removing medical items not associated with the individuals, financial items not associated with the individual, and insurance items not associated with the individual.

4. The method according to claim 1, wherein the determining comprises:
determining a total risk score associated with the medical data; and
in response to the total risk score being greater than a risk threshold, determining that the medical identity is being misused.

5. The method according to claim 4, wherein the determining a total risk score comprises:
comparing one or more items in the medical data to a corresponding item in the individual identifying data;
assigning a risk score to each comparison between the medical data and the individual identifying data; and
combining each risk score to obtain the total risk score.

6. The method according to claim 4, further comprising:
in response to the total risk score being greater than the risk threshold, locking the medical identity.

7. The method according to claim 6, wherein the medical identity is locked until the confirmation is received indicating that the medical identity is being used properly.

8. The method according to claim 1, wherein the individual identifying data and the medical data are selected from the group consisting of: (a) name of the individual, (b) password of the individual, (c) one or more pictures, (d) secret or security questions and/or answers, (e) one or more addresses of the individual, (f) one or more phone numbers, (g) primary and/or secondary service providers and tertiary contacts, (h) medical identities in clinical records, (i) medical insurance identities, (j) driver's license information, (k) historical medical plans, (l) references of the individual, (m) past and current medical conditions of the individual, (n) electronic health record references of the individual, and (o) combinations thereof.

9. The method according to claim 1, wherein the configuring comprises collecting a preferred method of communicating alerts to the individual, the preferred method selected from the group consisting of: text messaging, phone calls, email, and combinations thereof.

10. The method according to claim 1, wherein the monitoring comprises logging the preferences of the individual, the logging comprising logging a primary care physician of the individual, local hospitals of the individual, and regional specialties available to the individual.

11. A server for medical identity theft prevention, the server comprising a processor to execute computer executable instructions stored on a non-transitory computer readable medium, so that when the instructions are executed, the server is configured to:
register an individual to an identity theft service, wherein registering the individual comprises receiving individual identifying data from a computing device;
configure a profile for the individual based on the individual identifying data;
monitor use of a medical identity associated with the individual, wherein monitoring use of the medical identity comprises receiving medical data from one or more provider devices;
determine from the medical data whether the medical identity is being misused;
in response to the determining that the medical identity being misused, sending an alert to a victim device associated with the individual, the alert indicating the misuse of the medical identity; and
receive a confirmation from the individual through the victim device, the confirmation indicating whether the medical identity is being used properly.

12. The server according to claim 11, further configured to:
tag the medical data for resolution, resolution comprising assigning the profile for the individual to a special team, wherein the tagging is performed based on the confirmation indicating that the medical identity is not being used properly; and
perform resolution on the medical identity.

13. The server according to claim 12, wherein resolution further comprises:
determining that a medical record of the individual is falsely updated; and
cleansing the medical record of the individual of the false updates, the cleansing comprising removing medical items not associated with the individuals, financial items not associated with the individual, and insurance items not associated with the individual.

14. The server according to claim 11, further configured to:
determine a total risk score associated with the medical data; and
in response to the total risk score being greater than a risk threshold, determine that the medical identity is being misused.

15. The server according to claim 14, further configured to:
compare one or more items in the medical data to a corresponding item in the individual identifying data;
assign a risk score to each comparison between the medical data and the individual identifying data; and
combine each risk score to obtain the total risk score.

16. The server according to claim 14, further configured to:
in response to the total risk score being greater than the risk threshold, lock the medical identity.

17. The server according to claim 16, wherein the medical identity is locked until the confirmation is received indicating that the medical identity is being used properly.

18. The server according to claim 11, wherein the individual identifying data and the medical data are selected from the group consisting of: (a) name of the individual, (b) password of the individual, (c) one or more pictures, (d) secret or security questions and/or answers, (e) one or more addresses of the individual, (f) one or more phone numbers, (g) primary and/or secondary service providers and tertiary contacts, (h) medical identities in clinical records, (i) medical insurance identities, (j) driver's license information, (k) historical medical plans, (l) references of the individual, (m) past and current medical conditions of the individual, (n) electronic health record references of the individual, and (o) combinations thereof.

19. The server according to claim 11, further configured to:
collect a preferred method of communicating alerts to the individual, the preferred method selected from the group consisting of: text messaging, phone calls, email, and combinations thereof.

20. The server according to claim 11, further configured to:
log the preferences of the individual, wherein logging the preferences comprises logging a primary care physician of the individual, local hospitals of the individual, and regional specialties available to the individual.
